(19) United States
(12) Patent Application Publication
(10) Pub. No.: US 2020/0334142 A1
(43) Pub. Date: Oct. 22, 2020

(54) QUASI-COMPACTING GARBAGE COLLECTOR FOR DATA STORAGE SYSTEM

(71) Applicant: EMC IP Holding Company LLC, Hopkinton, MA (US)

(72) Inventors: Mikhail Danilov, Saint Petersburg (RU); Konstantin Buinov, Prague (CZ)

(21) Appl. No.: 16/388,060

(22) Filed: Apr. 18, 2019

(51) Int. Cl. G06F 12/02; G06F 3/06

(52) U.S. Cl. CPC G06F 12/0253; G06F 3/067; G06F 3/0608; G06F 3/0644; G06F 3/0604

(57) ABSTRACT

The described technology is generally directed towards quasi-compacting data storage chunks that obtains free capacity in used data chunks without moving data from those storage chunks. A composite data chunk is created from the unused block(s) within a data storage chunk. For example, blocks can be based on which fragments of a used data chunk are not in use (e.g., where a fragment is a one-twelfth, contiguous part of a chunk). A composite chunk thus uses the unused storage space of an existing “parent” data chunk, with mapping maintained to map from references to the composite chunks to actual addresses of their respective parent chunks. Quasi-compaction, such as used in conjunction with garbage collection, can be used to efficiently obtain more free storage capacity, without the inefficient copying of data from used chunks.

### TECHNICAL FIELD

The subject application generally relates to data storage, and, for example, to a data storage system of nodes that reclaims storage space, including without data copying, and related embodiments.

### BACKGROUND

Contemporary cloud-based data storage systems, such as ECS (formerly known as ELASTIC CLOUD STORAGE) provided by DELL EMC, can be based on a cluster of nodes that each owns some part of the stored data (and can store redundant data and/or erasure coded data for data protection purposes) in storage devices. For example, user data can be stored in a repository and the metadata (system metadata and metadata used to locate the user data) stored in search trees owned by a given node.

In ESC in general, disk space is partitioned into a set of blocks of fixed size called chunks. The information maintained in the cloud-based data storage system, including the user data and the various metadata, is stored in these chunks. For example, there are different types of chunks; user data is stored in repository chunks, while the metadata is stored in directory tables, where each directory table (DT) is a set of key-value search trees. Chunk content is modified in append-only mode; when a chunk becomes sufficiently full, that chunk gets sealed and becomes immutable.

Eventually, due to object deletion and the like, a sealed tree chunk becomes unused, in that no node within the node cluster references a tree element that is part of the unused tree chunk. In such a state, the unused tree chunk can be garbage collected and its space reclaimed. The fact that chunks are immutable generally does not allow implementing fine-grained reclamation (e.g., via garbage collection) of unused hard drive capacity, and thus an entire chunk is garbage collected as a unit. It is also feasible for a “copying” garbage collector to detect live object pages stored in chunks that are “sparsely filled” (below a usage capacity threshold) and copy the corresponding pages that are in use to new chunks, such that the live data is stored in the new chunks and the chunk capacity of the sparsely filled chunk can be reclaimed. However, garbage collection in general, and particularly copying garbage collection, is very slow and very resource demanding.

### BRIEF DESCRIPTION OF THE DRAWINGS

The technology described herein is illustrated by way of example and not limited in the accompanying figures in which like reference numerals indicate similar elements and in which:

FIG. 1 is an example block diagram representation of part of a data storage system including nodes, in which a garbage collector garbage collects unused data chunks and/or quasi-compacts data chunks, according to one or more example implementations.

FIG. 2 is an example representation of chunks identifiers and fragments of those chunks in use/not in use, to facilitate quasi-compaction, in accordance with various aspects and implementations of the subject disclosure.

FIG. 3 is a representation of chunks identifiers arranged by blocks of free space in the chunks, to facilitate quasi-compaction, in accordance with various aspects and implementations of the subject disclosure.

FIGS. 4A and 4B are representations of a tree structure (FIG. 4A) and chunk space (FIG. 4B) that maintains the tree structure, in which unused chunk space is used for quasi-compaction, in accordance with various aspects and implementations of the subject disclosure.

FIG. 5A is a representation of using free blocks in chunks to create a composite chunk via quasi-compaction, in accordance with various aspects and implementations of the subject disclosure.

FIG. 5B is a representation of maintaining mapping information for composite chunk identifiers, in accordance with various aspects and implementations of the subject disclosure.

FIG. 6 is an example block diagram representation of combining multiple lists of used chunk identifiers and fragment information for use in quasi-compaction, in accordance with various aspects and implementations of the subject disclosure

FIG. 7 is a flow diagram showing example operations related to quasi-compaction to create composite chunks, in accordance with various aspects and implementations of the subject disclosure

FIG. 8 is an example block diagram representation of chunks owned by nodes and managed by respective chunk managers, in which the chunks are possible candidates for garbage collection and accompanied by fragment information, in accordance with various aspects and implementations of the subject disclosure.

FIG. 9 is an example block diagram representation of chunks and fragments used by nodes, in which unused chunks are ready for garbage collection, in accordance with various aspects and implementations of the subject disclosure.

FIG. 10 is an example block diagram representation of data structures (e.g., lists) of chunks used by nodes, in which the used chunks are not to be garbage collected but can possibly be quasi-compacted, in accordance with various aspects and implementations of the subject disclosure.

FIG. 11 is an example block diagram representation of data structures (e.g., lists) of chunks owned by nodes that are also in use, in which the chunks in use are not to be garbage collected, and the chunks in use (possibly) quasi-compacted in accordance with various aspects and implementations of the subject disclosure.

FIG. 12 is an example block diagram representation of nodes evaluating lists of owned chunks against lists of used chunks to determine unused chunks that are to be garbage collected, in accordance with various aspects and implementations of the subject disclosure.

FIG. 13 is an example block diagram representation of nodes garbage collecting owned, unused chunks, in accordance with various aspects and implementations of the subject disclosure.

FIG. 14 is a flow diagram showing example operations of a node that owns data structures (e.g., trees) and uses chunks referenced by those data structures to determine chunks in use and fragments in use of those chunks in use, in accordance with various aspects and implementations of the subject disclosure.

FIG. 15 is a flow diagram showing example operations of a node that owns chunks and uses data structures (e.g., lists) of chunks in use to determine owned, unused chunks for garbage collection and fragments not in use of the chunks in use for quasi-compaction, in accordance with various aspects and implementations of the subject disclosure.

FIG. 16 is a flow diagram showing example operations related to creating composite chunks from unused blocks within used chunks, in accordance with various aspects and implementations of the subject disclosure.

FIG. 17 is a block diagram showing example operations related to using unused fragments of used chunks to create composite chunks, in accordance with various aspects and implementations of the subject disclosure.

FIG. 18 is a flow diagram showing example operations related to determining unused chunk fragments from a dataset of used, owned chunks for use in creating composite chunks, in accordance with various aspects and implementations of the subject disclosure.

FIG. 19 depicts an example schematic block diagram of a computing environment with which the disclosed subject matter can interact, in accordance with various aspects and implementations of the subject disclosure.

FIG. 20 illustrates an example block diagram of a computing system operable to execute the disclosed systems and methods in accordance with various aspects and implementations of the subject disclosure.

### DETAILED DESCRIPTION

Various aspects of the technology described herein are generally directed towards a quasi-compacting garbage collector, including for use with B+ trees. As described herein, the technology facilitates fine-grained capacity reclamation without resource-demanding data copying.

In general, the quasi-compacting garbage collector detects blocks of unused capacity (“unused blocks”) within used tree chunks. The quasi-compacting garbage collector can verify the unused blocks to make sure their capacity can be safely reclaimed. The capacity of the unused blocks can be reclaimed, while their parent chunks remain in use; to this end, reclaimed blocks can be used to create new composite (logical) tree chunks, with mapping information maintained between the composite tree chunk blocks and the physical addresses within their parent tree chunk blocks. In this way, capacity is reclaimed without slow and resource-demanding copying of live (in-use) data.

When capacity of some unused block within a used chunk is reclaimed, the logical length of the chunk decreases by the size of the unused block, while the density of live data inside the resulting chunk increases. This concept is referred to herein as “quasi-compacting,” where the term “quasi-” is used to indicate there is no actual movement of data, in contrast with conventional compacting garbage collection (e.g., copying) techniques that compact unused capacity by moving/copying live data out of a chunk.

In one implementation, the quasi-compacting garbage collector described herein can work in conjunction with another garbage collector, e.g., the already-existing copying garbage collector. The combined garbage collector assures fast capacity reclamation via quasi-compaction, while the copying garbage collector may perform a slow space reclamation operation at a later time, such as when more computing resources are available.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations.

As will be understood, the implementation(s) described herein are non-limiting examples, and variations to the technology can be implemented. For instance, examples are based on the ECS data storage system, however the technology described herein can be used by any data storage system that has multiple nodes. Moreover, while metadata trees and chunks are described, it is understood that any type of chunks that are owned and unused can be identified and garbage collected based on the technology described herein, such as user chunks or other units of data that are not necessarily referenced by a tree of metadata, but, for example, referenced by some other data structure (e.g., hash maps). As such, any of the embodiments, aspects, concepts, structures, functionalities, implementations and/or examples described herein are non-limiting, and the technology may be used in various ways that provide benefits and advantages in data storage technology and garbage collection in general.

Aspects of the subject disclosure will now be described more fully hereinafter with reference to the accompanying drawings in which example components and operations are shown, and wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure. Thus, the subject disclosure may be embodied in many different forms and should not be construed as limited to the examples set forth herein.

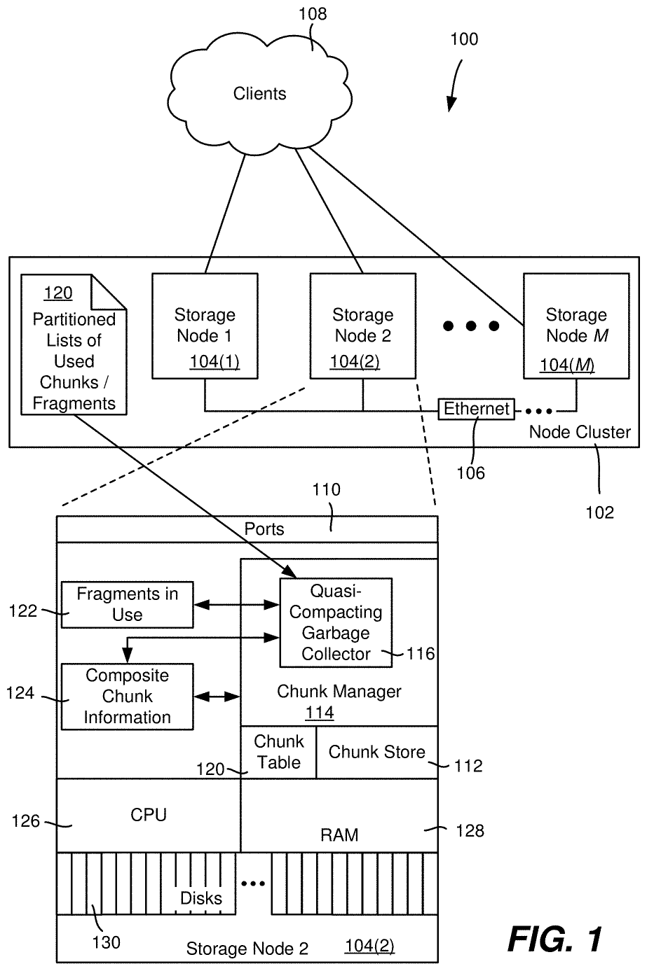

FIG. 1 shows part of a data storage system 100 (such as ECS) comprising a node cluster 102 of storage nodes 104(1)-104(M), in which each node is typically a server configured primarily to serve objects in response to client requests. The nodes 104(1)-104(M) are coupled to each other via a suitable data communications link comprising interfaces and protocols, such as represented in FIG. 1 by Ethernet block 106.

Clients 108 make data system-related requests to the cluster 102, which in general is configured as one large object namespace; there may be on the order of billions of objects maintained in a cluster, for example. To this end, a node such as the node 104(2) (shown enlarged in FIG. 1 as well) generally comprises ports 110 by which clients connect to the data storage system 100. Example ports are provided for requests via various protocols, including but not limited to SMB (server message block), FTP (file transfer protocol), HTTP/HTTPS (hypertext transfer protocol) and NFS (Network File System); further, SSH (secure shell) allows administration-related requests, for example.

Each node, such as the node 104(2), includes an instance of a data storage system and data services; (note however that at least some data service components can be per-cluster, rather than per-node). For example, ECS™ runs a set of storage services, which together implement storage logic. Services can maintain directory tables for keeping their metadata, which can be implemented as search trees. For example, a blob service maintains an object table (e.g., in various partitions among nodes) that keeps track of objects in the data storage system and generally stores their metadata, including an object's data location information, e.g., within a chunk. There is also a “reverse” directory table (maintained by another service) that keeps a per chunk list of objects that have their data in a particular chunk.

FIG. 1 represents some additional concepts, in that the chunks, including the user data repository of chunks, is maintained in a chunk store 112, managed by another storage service referred to as a chunk manager 114. A chunk table 120 maintains metadata about chunks, e.g., as managed by the chunk manager 114.

In one or more implementations, garbage collection is a duty of the chunk manager 114, represented in FIG. 1 as a quasi-compacting garbage collector 116. The quasi-compacting garbage collector 116 is coupled to (or incorporated into) the chunk manager 114, which in turn is coupled to the chunk store 112 to garbage collect chunks and create composite chunks as described herein. More particularly, garbage collection is implemented at the chunk level, and operates to only collect empty chunks, that is, those that do not contain live data. It is also feasible for a the garbage collector 116 to (at least at times) operate as a copying garbage collector that copies parts that are in use in a sparsely filled chunk to a new chunk, to thereby make the sparsely filled chunk completely unused and thus able to be garbage collected.

With respect to quasi-compaction, in one or more implementations, the quasi-compacting garbage collector 116 obtains a list 120 of chunks that are in use and owned by the storage node 104(2). For each chunk that is in use, information 122 (e.g., a bitmap for each chunk in the list 120) indicates which fragments of that chunk are in use and which are not in use. Those fragments that are not in use can be used as blocks to create one or more composite chunks as described herein. The chunk manager 114 maintains composite chunk information 124 to map I/O requests to composite chunks to their actual physical addresses within a chunk in use as also described herein.

In FIG. 1, a CPU 126 and RAM 128 are shown for completeness; note that the RAM 126 may comprise at least some non-volatile RAM. The node 104 (2) includes storage devices such as disks 128, comprising hard disk drives and/or solid-state drives, or any other suitable type of storage resource. As can be readily appreciated, components of the data storage system including those described herein can be at various times in any storage device or devices, such as in the RAM 128, in the disks 130, or in a combination of both, for example.

As set forth above, fragments may be the underlying storage unit for blocks used in composite chunks. More particularly, in order to avoid uncontrolled capacity fragmentation and reduce the amount of system metadata to be kept, in one or more implementations the quasi-compacting garbage collector 116 can ignore small unused blocks and uses alignment. For example, with ECS tree chunks are protected with triple mirroring, while chunks with user data, known as repository (Repo) chunks, are protected with erasure coding. Each repository chunk, by default, is divided into twelve data fragments of the same size, with four redundant coding fragments, also of the same size, produced using the twelve data fragments. Such data and coding fragments are stored across an ECS cluster. As a result, ECS works with capacity blocks of a fragment size (e.g., chunk size/12). Therefore, in one or more implementations the quasi-compacting garbage collector 116 works with unused blocks of sizes that are multiples of a fragment size. The appropriate unused blocks alignment may be used (e.g., a block's offset within a chunk may be i*chunk size/12, where i is a natural number from 0 to 11).

In order to perform quasi-compaction, the quasi-compacting garbage collector 116 needs to gather information not only about chunks in use, but also about their “fragments” in use. Location of a page, which is a container for tree elements, may be described with a chunk ID, offset within the chunk and size. Offset and size can be used to identify chunk fragments that store a given page. Note that a page is normally smaller than a fragment, but there is no alignment; one page may cross the border between two fragments.

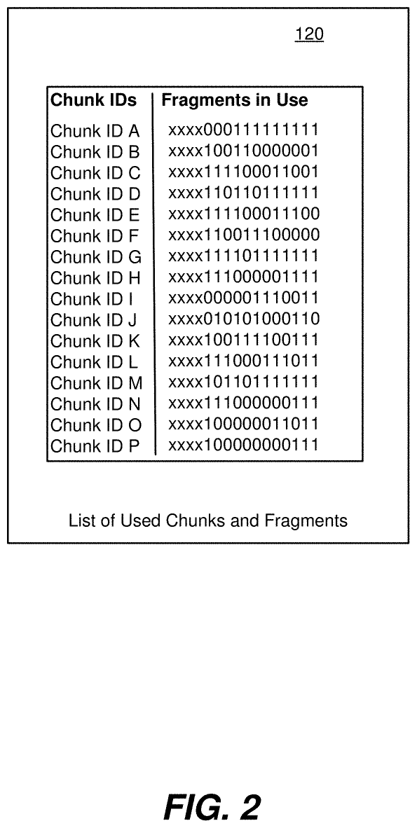

As shown in FIG. 2, each chunk in a list 120 of chunks in use can be accompanied with data structure, (e.g., a basic bitmap) of used chunk fragments. In the example of FIG. 2, the chunks identifiers are identified as Chunk IDs A-P (the list 102 itself is sorted by chunk ID for fast comparison with a list of known chunks) with A-P representing any suitable chunk identifiers. Each of the bitmaps has a “1” to indicate a fragment “in use” or a “0” to indicate a fragment “not in use”—e.g., a bitmap of 000000100000 means that the seventh chunk fragment is in use. For ECS, a two-byte bitmap is sufficient, (16 bits>12 fragments), and in the example of FIG. 2, the four most significant bits “xxxx” are reserved, while the twelve least significant bits carry the fragment information.

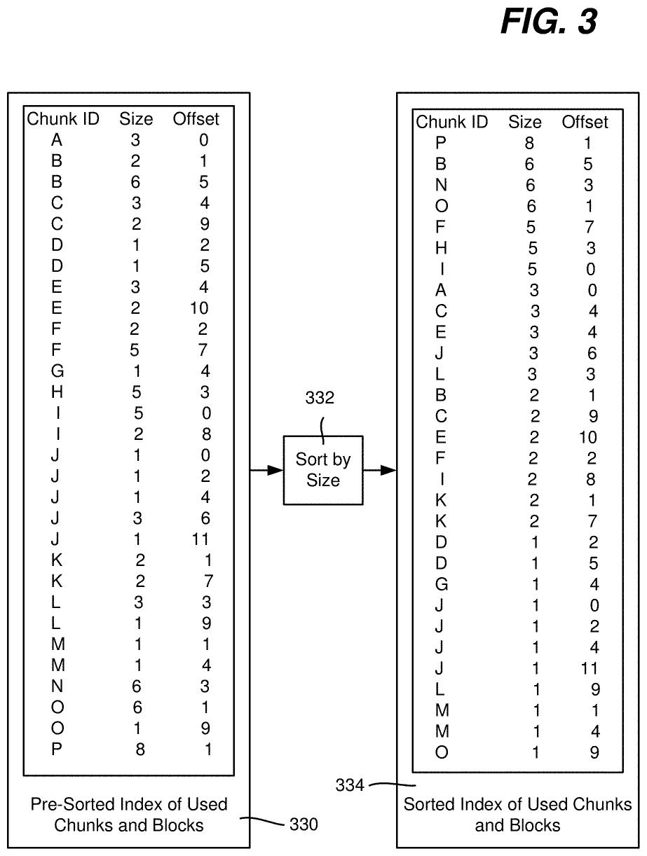

As represented in FIG. 3, an index 330 (or other suitable data structure) may be created for a list of chunks in use (the list itself is sorted by chunk ID for fast comparison with a list of known chunks). If a chunk has multiple groups of one or more unused blocks, the chunk manager enters the chunk identifier into the index multiple times. For instance, a chunk with bitmap 000000100000 enters the index one time with a half a chunk (size six) unused block and another time with an unused block of size 5 (5/12*chunk size), with the offset information maintained. Note that the offset ranges from 0 to 11, e.g., the first bit is offset 0, the twelfth bit is offset 11.

In one or more implementations, entries in the index 330 are sorted (block 332) by the sizes of an unused block they contain, largest unused blocks first, as represented in the sorted index 334. Note that although FIG. 3 can be interpreted as fully entering the index with chunk identifiers, sizes and offsets first, and then sorting, it is feasible to perform sorting (at least to some extent) as entries are being entered. It can be readily appreciated that sorting is only an optimization, and indeed, selection of unused blocks can be in any order, random, or by sized-based selection from an unsorted list such as the list 332.

During garbage collection, known chunks that are not in the list of used chunks 120 are deleted first. Quasi-compaction may be a conditional operation, such as performed only when the amount of available free capacity in the data storage system is below some threshold capacity value; (note however that quasi-compaction can be unconditional). For example, if after the unused chunks have been deleted and their capacity has been reclaimed, the amount of available free capacity is below the threshold, the garbage collector may commence quasi-compaction, e.g., starting with the largest unused blocks from the sorted index 334, and stop quasi-compaction when the threshold is reached.

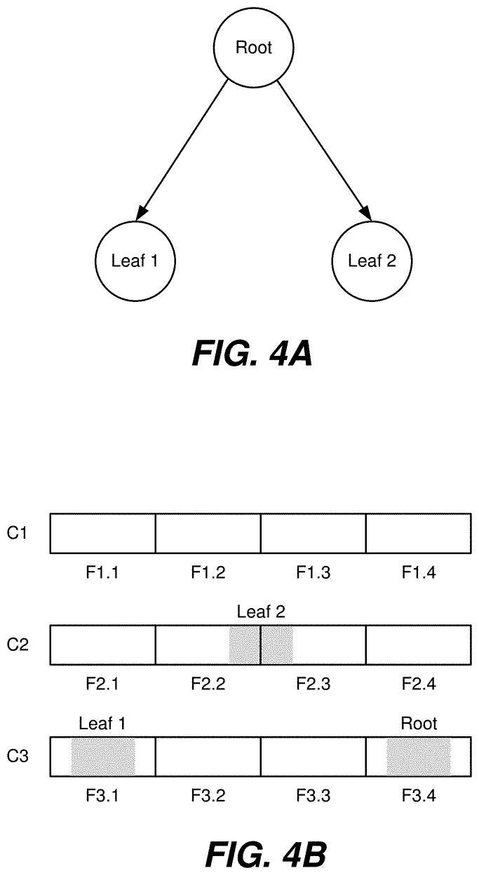

By way of a simplified (four fragments/chunk) example, consider that quasi-compaction is unconditional, in which all properly aligned unused blocks of a fragment size or larger are reclaimed, whereby there is no need for an index of unused blocks (all will be used). In FIG. 4A, the data storage system has just one tree (a B+ tree) in this example, in which the tree has three elements, a Root, Leaf 1 and Leaf 2.

The data storage system is aware of the three chunks shown in FIG. 4B, namely chunks C1, C2 and C3. Each chunk has four “fragments” that are identified with a pair chunk #.fragment #, such as the fragment 2.3 (chunk ID 2, fragment 3).

As represented by the blank (non-shaded) fragments F1.1-F1.4, the chunk C1 contains no live data. Chunk C2 stores Leaf 2, which occupies a part of fragment F2.2 and a part of fragment F2.3; (recall that a tree element such as the leaf L2 is stored in a page, which is independent of fragment boundaries). Chunk C3 stores Leaf 1, which resides in fragment F3.1, and the tree Root element, which resides in fragment F.3.4.

Traversal of the tree provides the list of used chunks shown in the Table below:

| Used Chunks | Fragments Bitmap |
|---|---|
| C2 | 0 1 1 0 |
| C3 | 1 0 0 1 |

Note that the above list/table need not contain information about chunk C1 because the chunk C1 contains no tree element. Chunk C2 goes to the list with bitmap 0110, which indicates that the two fragments in the middle (F2.2 and F2.3) contain some live data. Chunk C3 goes to the list with bitmap 1001, which indicates that the two fragments in the middle contain no live data, that is, the first and last fragments (F3.1 and F3.4) of chunk C3 contain some live data.

As set forth above, in this example the known chunks are C1, C2 and C3, which, when compared with the above used chunk table, allows the system to reclaim capacity of four unused blocks. A first block is chunk C1; all four fragments are unused and contiguous, resulting in a size four block. The second and the third blocks are the fragments F2.1 and F2.4 (each size 1) of chunk C2. The last block is a union of fragments F3.2 and F3.3 of chunk C3, that is, a size two block.

After garbage collection is over, the system has the free capacity blocks listed in the table below:

| Free Blocks | Block Size |
|---|---|
| F1.1-F1.4 | 4 (Chunk size) |
| F2.1 | 1 (Chunk size/4) |
| F2.4 | 1 (Chunk size/4) |
| F3.2-F3.3 | 2 (Chunk size/2) |

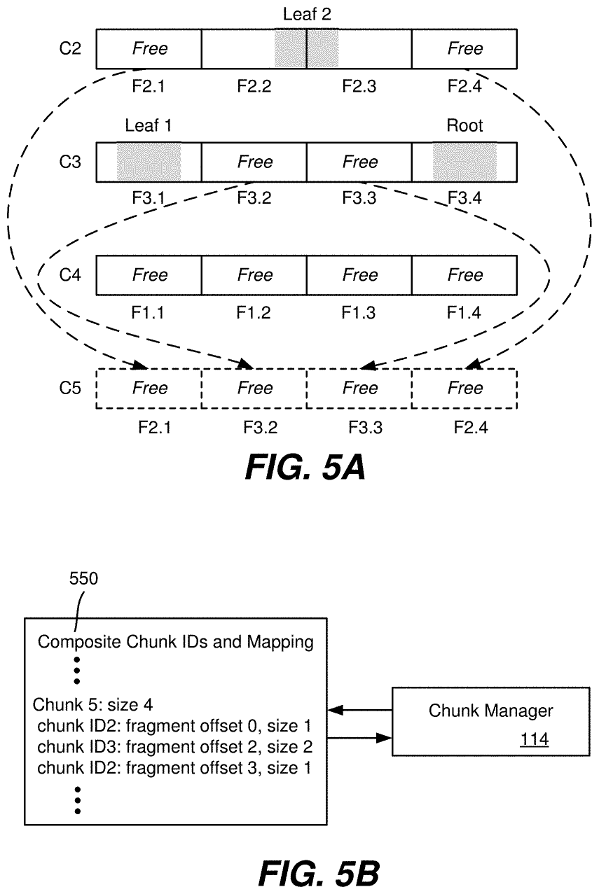

As represented in FIG. 5A, the four unused blocks above can be used to create two new chunks, comprising one normal chunk C4 and one composite chunk C5 (using the original fragments' IDs to indicate the blocks of capacity for purposes of reference). Chunks C2 and C3 remain in the system without moving any data. The first new chunk, chunk C4, was created over the largest free capacity block, as chunk C4 was reclaimed after the deletion of chunk C1.

By way of quasi-compaction, chunk C5 is a composite chunk. The composite chunk c5 was created using only the available unused blocks of smaller sizes. Note that the composite chunk C5 does not occupy its own space, but rather is a logical chunk made up of unused fragments (F.2.1, F3.2, F3.3 and F2.4) in this example.

As shown in FIG. 5B, the chunk manager 114 retains the composite chunk information 550 (actual chunk ID, which can instead be a chunk address offset of that chunk), fragment offset and block size. The chunk manager maintains this information 550 so that addresses within the composite chunk can be translated to real addresses as needed.

Turning to another aspect, in one or more implementations an ownership-based garbage collection technology is available, in which a given node owns/manages certain chunks as partitioned throughout the nodes of the data storage system. Such an ownership-based garbage collection technology can be used in conjunction with the quasi-compacting garbage collector 116, e.g., as an underlying engine.

In the ownership-based garbage collection technology, any other node can use (store data in) another node's owned chunks; however an owning node only garbage collects its owned unused chunks. To this end, the system traverses the B+ trees to produce a list of tree chunks in use, that is, those chunks that have at least one live tree element inside. The system compares the list of tree chunks in use with the list of known tree chunks. A tree chunk that is in the list of known chunks but not in the list of used chunks contains no live data. Such a chunk can be deleted, with the capacity occupied by a deleted chunk can be reclaimed and reused.

In general, at garbage collection time, for each node that owns a chunk (the owning node), the other nodes provide the owning node with a list of the chunks in use that it is using and are owned by the owning node. The owning node combines these other lists with its own list of owned, used chunks, and based on the combined list deletes any chunks that the owning node owns that are not in use. By having each node garbage collect based on the nodes that it owns, garbage can be collected in one run.

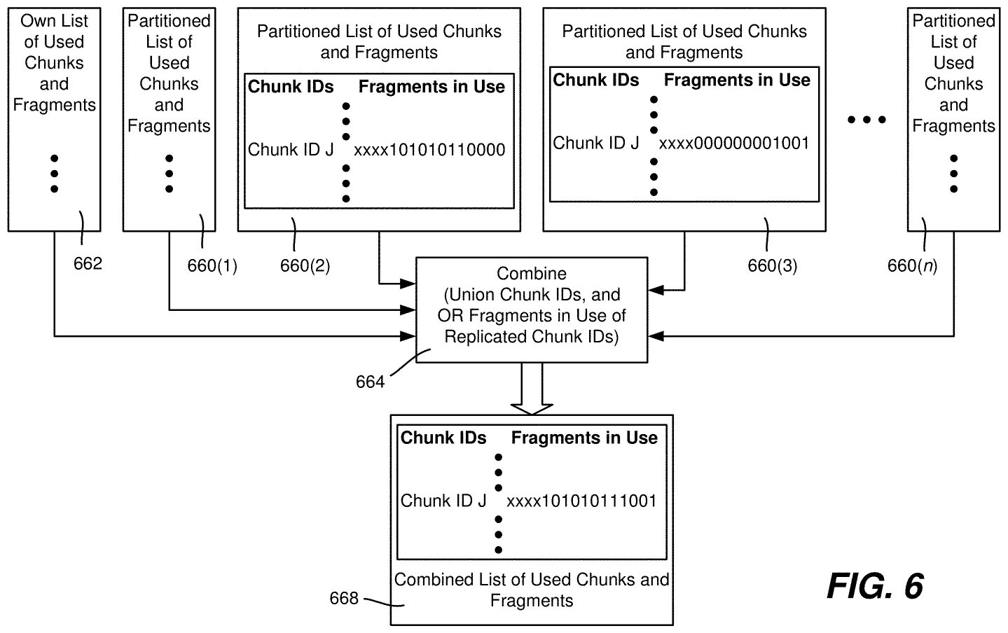

As shown in FIG. 6, consider that an owning node obtains lists 660(1)-660(n) from the other nodes in the system comprising the chunks in use (containing live data) by those nodes. The node that owns these chunks also may use its own nodes, as present within a list 662. The owning node combines (block 664) the lists 660(1)-660(n) and 662, including performing a union operation on the chunk identifiers in the datasets, and thereby knows which of the chunks that it owns are in use (block 668), and thus can subtract the chunks in use from the set of chunks that are owned to obtain a dataset of the chunks not in use, which are then deleted to reclaim their space.

As described herein, the chunks in use are accompanied by a data structure (e.g., the bitmap) indicating which fragments are in use, and which are unused and therefore free to be used in composite chunks as needed via quasi-compaction. To combine the bitmaps when combining the lists (block 664), for each chunk in use that is replicated (is listed on more than one list), the bitmaps also need to be combined. To this end, when multiple lists are combined, a united bitmap for a chunk is a result of a logical OR operation over the bitmaps for this chunk from different lists (for instance, created for different trees). This is exemplified in FIG. 6, in which a chunk ID J appears in two lists, 660(2) and 660(3), with respective bitmaps of 101010110000 and 000000001001 logically OR'ed to provide the combined bitmap 101010111001 in the combined list of used chunks and fragments 668.

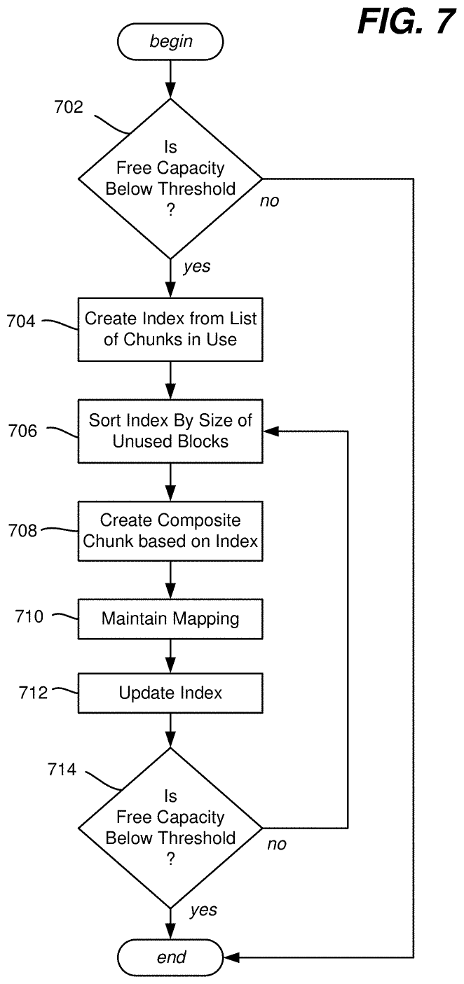

FIG. 7 summarizes example operations related to creating composite chunks, such as when storage capacity is deemed to be needed (e.g., block 702). Operation 704 represents creating the index of available block space from unused fragment information, and operation 706 represents sorting the index based on the size of unused blocks, as described above with reference to FIG. 3.

Operation 708 represents creating a composite chunk based on the blocks identified in the index. Operation 710 represents maintaining the mapping of the composite chunk, e.g., so that a reference to the (logical) composite chunk is mapped to the correct physical addresses in the parent chunk at which the block(s) actually reside. Operation 712 updates the index so that the selected block(s) are no longer available. Note that the chunk manager is performing these operations, and thus also knows that the block space reallocated for the composite chunk is not available for any other use, e.g., as referenced by the chunk identifier of the parent chunk.

Operation 714 repeats the process until desired storage capacity is available via the composite chunks. Note that the free capacity threshold is only one way to make quasi-compaction conditional, and also that the free capacity threshold at operation 702 need not be the same as the free capacity threshold at operation 714. For example, if quasi-compaction is performed, some minimum number of gigabytes can be reclaimed beyond the starting threshold by having the threshold start the process at X gigabytes free capacity threshold but not stop until Y gigabytes free capacity threshold is reached (where Y>X).

Because of the management (mapping) overhead in both space and computations, composite tree chunks are less preferable than conventional chunks. Indeed, in some cases writing to and reading from a composite chunk is slower than for a conventional chunk. Thus, the quasi-compacting garbage collector (the quasi-compaction portion thereof) may be used only when it is apparent that other garbage collection operations cannot reclaim space fast enough, whereby users will get a “no capacity” error shortly.

After capacity of an unused block is reclaimed, the resulting chunk may become split into two or more blocks. Once the quasi-compacting and the other (e.g., copying) garbage collectors have finished their cycles, small unused blocks with size less than a chunk size can be joined to get unused blocks of the standard chunk size or larger. With respect to a larger chunk size, consider a chunk that has its first half reclaimed using the quasi-compacting garbage collector and the second half reclaimed using the copying garbage collector. If the two resulting blocks are still free, they can be united into a block; if there is another free block next to the ex-chunk, it may be added to the free block of the chunk size and, as a result, get a free block that is larger than a chunk.

Turning to the concept of garbage collection and composite chunk creation via quasi-compaction in a chunk ownership-based environment, a hash function is used to derive a home tree/partition for a given key, and thus each tree is owned by one cluster node; (even though the elements of that tree can be in a tree chunk owned by another node). One aspect of partitioning is that a node can own a chunk but not use it and/or even store that chunk within its storage devices. This can be exemplified via a chunk manager, the storage service of the ECS storage services that manages chunks. A chunk manager keeps information about chunks in chunk table (CT), which is a DT. Given a chunk C and a partition P of a CT that keeps the system metadata for chunk C, there is some node N that owns partition P. Significantly, although the node N owns chunk C via partition P, the node N may contain zero bytes of chunk C data in its storage devices.

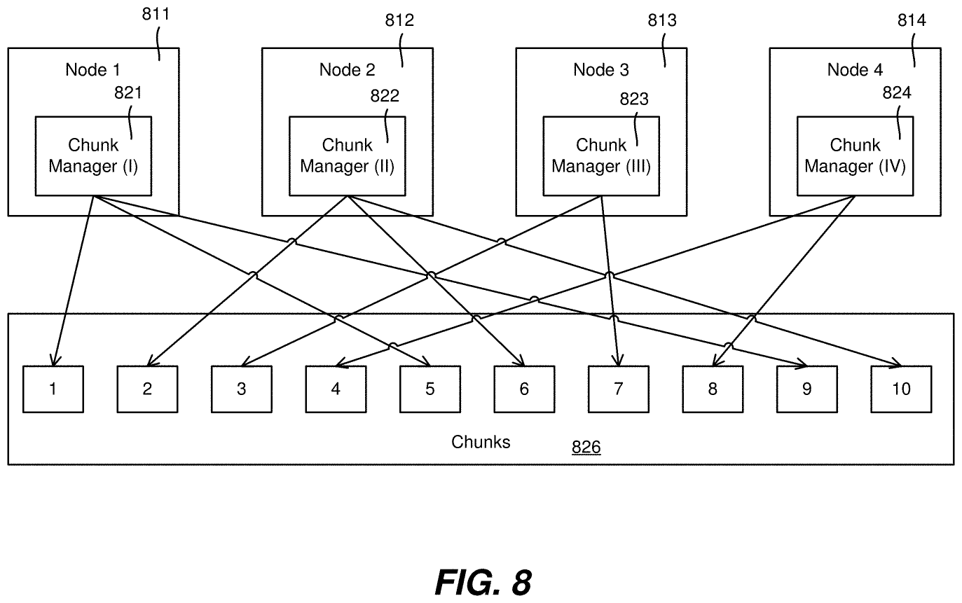

With respect to garbage collection technology as described herein, as represented in the example four-node cluster with four chunk table partitions of FIG. 8, there is a cluster that comprises nodes 811-814. In this example, there are ten chunks 826, e.g., identified by chunk identifiers (1-10). The arrows in FIG. 8 show which of the nodes 811-814/respective chunk manager instances 821-824 (one per node), via corresponding chunk table partitioning (Roman numerals (I)-(IV)), manage which chunks. Thus, in FIG. 8, it can be seen by the arrows that in this particular example, the node 1 labeled 811/chunk manager (I) 821 owns (manages) chunks 1, 5 and 9, the node 8 labeled 812/chunk manager (II) 822 owns chunks 8, 6 and 10, the node 3 labeled 813/chunk manager (III) 823 owns chunks 3 and 7, and the node 4 labeled 814/chunk manager (IV) 824 owns chunks 4 and 8.

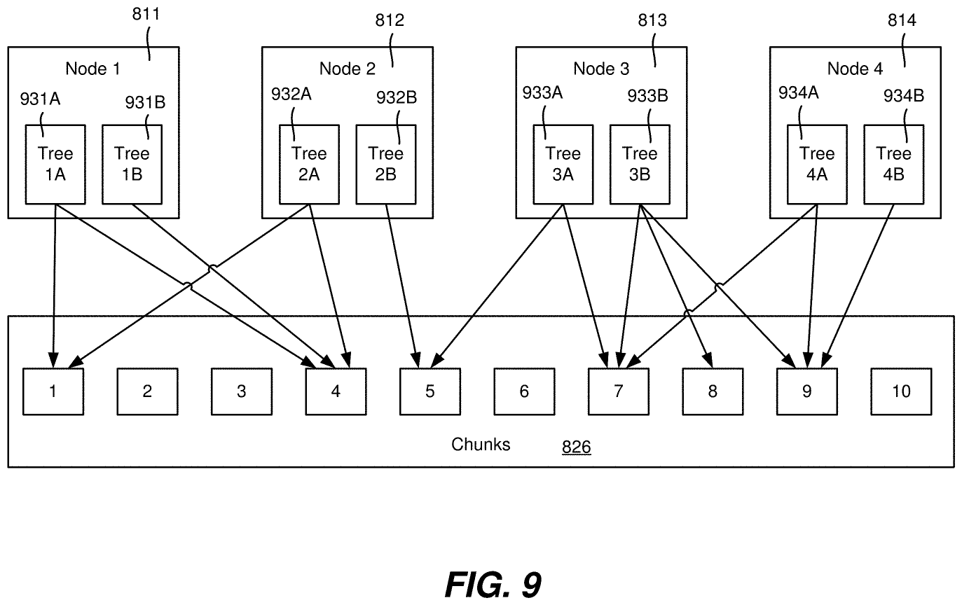

Continuing with the example herein, as shown in FIG. 9, the cluster nodes 811-814 each owns two trees; that is, in FIG. 9 the node 1 (211) owns tree 1A labeled 931A and tree 1B labeled 931B, the node 8 (212) owns tree 8A labeled 932A and tree 8B labeled 932B, and so on. As set forth herein, trees are only an example of one suitable data structure, and instead of (or in addition to) trees, other data structures (e.g., hash maps) can be used to reference and maintain metadata.

When it is time to start the garbage collector, the arrows in FIG. 9 shows which trees use (have data in) which chunks in this example. As can be seen from FIGS. 8 and 9, the node 1 (811) owns nodes 1, 5 and 9 (FIG. 8), and has data in chunk ID 1 (owned by node 1 (811) and chunk ID 4; (chunk ID 4 is owned by the node 4 (814)). Thus, it can be seen that the tree 1A labeled 931A of the node 1 labeled 811 uses chunk 1, which it also owns, and chunk 4, which node 811 does not own. The tree 1B labeled 931B of node also uses chunk 4, owned by node 814, as does the tree 8A 932A of the node 812. Thus, as shown in FIGS. 8 and 9, the trees of the various nodes 811-814 use various chunks 826 labeled 1-10, some chunks(s) of which can be owned by the node that uses that chunk, while other(s) of which can be owned by one or more other nodes.

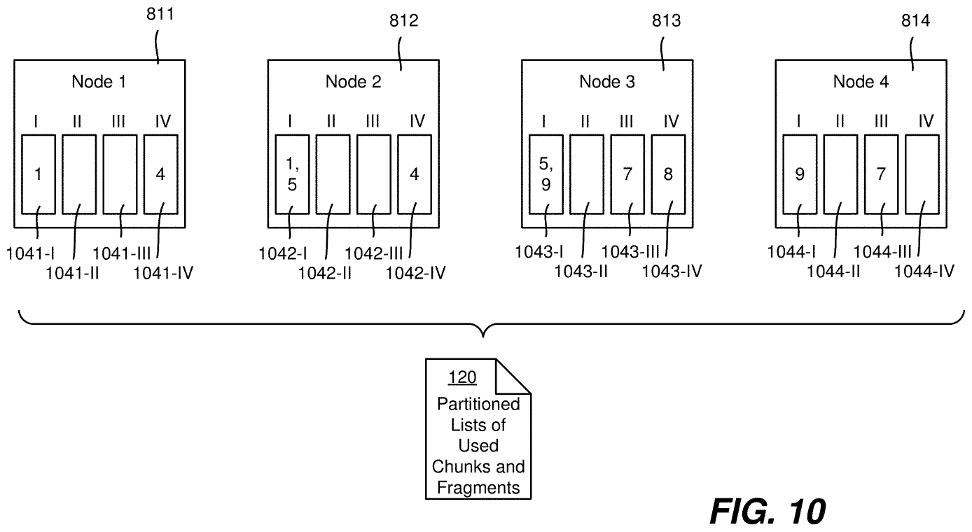

As represented in FIG. 10, each node traverses its trees or other data structures to produce a list of chunks in use by that node. Note that a chunk that is not sealed is still considered in use; (if there is any other reason to not garbage collect a particular chunk, that chunk can also be considered in use). Each node's main list is partitioned using the chunk table's hash function, so that a list is obtained for each other node, as well as the node itself. Thus, from FIG. 8, node 1 owns chunks 1, 5 and 9, and from FIG. 9 uses chunks 1 and 4; when hashed below into partitioned lists of chunks in use as in FIG. 9, the node 211 has four lists 1041-I-1041-IV, with each list corresponding to one of the nodes 211-214. As can be seen, the partitioned lists 1041-I, 1041-II, 1041-III and 1041-IV are generated by node 1 (211), the partitioned lists 1042-I, 1042-II, 1042-III and 1042-IV are generated by node 2 (212), the partitioned lists 1043-I, 1043-II, 1043-III and 1043-IV are generated by node 3 (213), and the partitioned lists 1044-I, 1044-II, 1044-III and 1044-IV are generated by node 4 (814). These lists are persisted, e.g., into the partitioned lists of used chunks 120 (although it should be noted that for garbage collection, a node need not make available to other nodes its owned list of chunks in use by itself, e.g., the node 1 (811) can locally maintain the partitioned list 1041-1 because no other node needs that list for garbage collection).

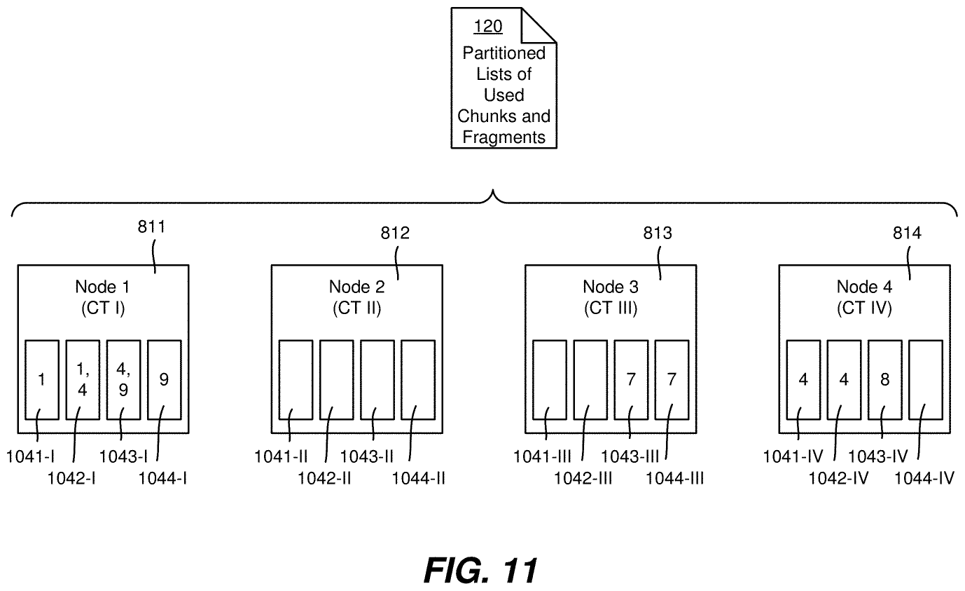

As shown in FIG. 11, each node 811-814 obtains the lists of chunks in use that are owned by that node. Empty lists are also obtained, so as to ensure that the other nodes have each traversed its trees (or other data structures). Thus, the node 1 (811) obtains partitioned lists 1041-I, 1042-I, 1043-I and 1044-I, the node 2 (212) obtains partitioned lists 1041-II, 1042-II, 1043-II and 1044-II, and so on. At this point, each node knows which of its owned chunks are in use. Note that the lists for node 1 (811) can only have chunk IDs of 1, 5 and 9, because those are the chunks owned by the node 1 (811). Similarly, because the node 2 (812) owns chunks 2, 6 and 10, the hashed lists 1042-I, 1042-II, 1042-III and 1042-IV for node 2 (812) could only contain chunk IDs of 2, 6 and 10 (although these lists are blank, because chunks 2, 6 and 10 are not in use). Likewise, because the node 3 (813) owns chunks 3 and 7, the hashed lists 1043-I, 1043-II, 1043-III and 1043-IV for the node 3 (813) can only contain blanks or chunk IDs of 3 and 7 (although only chunk 7 is in use). Lastly, the node 4 (814) owns chunks 4 and 8, so the partitioned lists 1044-I, 1044-II, 1044-III and 1044-IV for the node 4 (814) contain only a blank, a chunk ID 4 and/or a chunk ID 8.

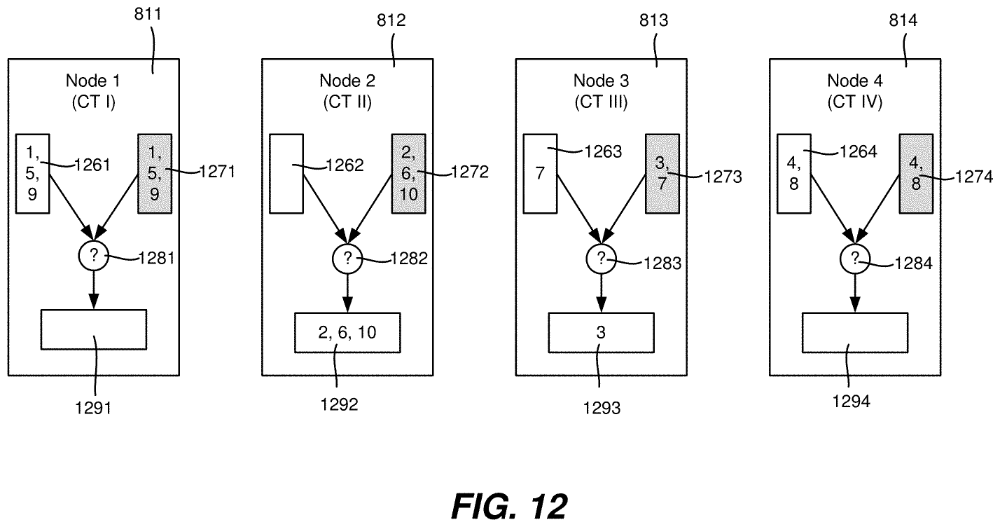

Once a node has its lists of owned, used chunks, each node combines (unions) the chunk identifiers of its own lists. As shown in FIG. 12, the combined lists are vertical rectangles with white backgrounds, labeled 1261-1264. The union-ing of the lists can be performed by sorting the chunk identifiers and removing duplicate identifiers; further, the fragment information in the respective bitmaps can be logically OR′ed as described herein.

In FIG. 12, the owned chunk lists in CT partitions (the chunks each node owns) are shown as vertical rectangles with grey backgrounds 1271-1274 in FIG. 12. To determine unused chunks, each node subtracts (represented by the circled question marks “?” labeled 1281-1284) its combined list of chunk identifiers in use from those that are owned by that node, to provide a difference dataset of owned, unused chunks. These datasets for the nodes 811-814 are shown in FIG. 12 as horizontal rectangles 1291-1294, respectively, each containing zero or more chunk IDs.

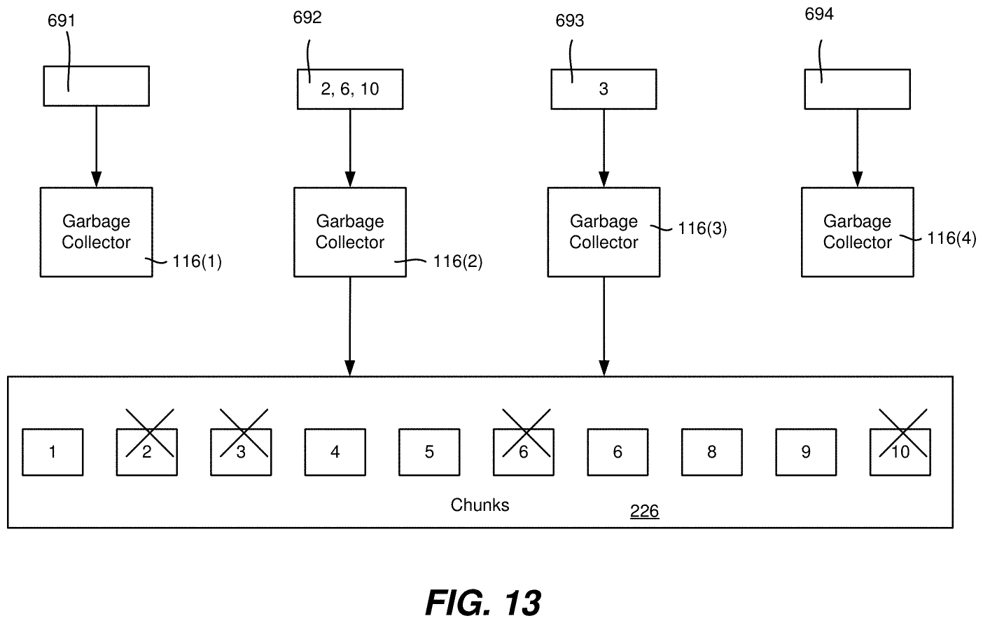

As shown in FIG. 13, these differences datasets 1291-1214 are used by respective garbage collector instances 122(1)-122(4) to garbage collect unused (sealed) chunks, that is, delete those chunks and reclaim their storage space. Note that it is alternatively feasible to have the difference datasets combined into a single list that is used by a cluster-wide garbage collector. Thus, continuing with the example of FIGS. 8-13, the unused chunks are 2, 3, 6 and 10, which are deleted (or marked for deletion) as represented by the crossed “X” over those chunks within the set of chunks 226.

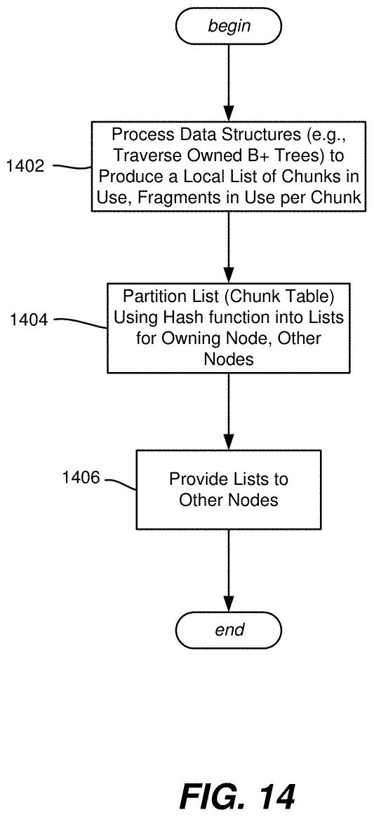

To summarize, as represented in FIG. 14, each cluster node/storage service traverse (traces) at operation 1402 the B+ trees (and/or other data structures) owned by that node to produce a local list of chunks in use, as well as the fragments in use per chunk. Those are chunks and fragments that have at least one live element inside, for example. At operation 1404, the list of used chunks may be partitioned using the chunk table hash function; note that in one more implementations in which there are 128 partitions, the initial list of used chunks corresponds to a union of 128 smaller lists. Operation 1406 makes those lists available to the other nodes of the node cluster.

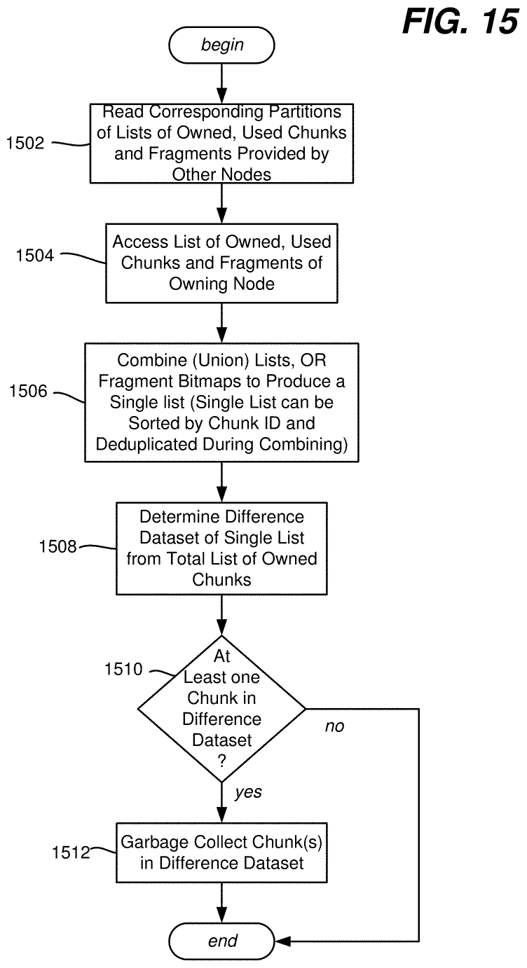

Each cluster node that owns at least one chunk table partition performs the example operations of FIG. 15 for each chunk table partition it owns, beginning at operation 1502 which represents the node reading the corresponding partitions of lists of used chunks and fragments from other nodes. Operation 1504 represents a node obtaining its own list of used, owned chunks and fragments, e.g., from local storage.

Operation 1506 represents combining the lists to produce a single list. The list may be sorted by chunk ID and deduplicated during combining, while the fragment bitmaps are logically OR′ed. Operation 1508 compares the combined list with the set of owned chunks to determine the difference dataset. Via operations 1510 and 1512, each owned chunk that is not in the combined list of used chunks and is ready for garbage collection (e.g., is sealed, etc.), can be deleted. The capacity occupied by deleted chunks can be reclaimed and reused.

Thereafter, if quasi-compaction is desired (e.g., free capacity is below a threshold free capacity value), then the operations of FIG. 7, as also described with reference to FIGS. 1-6 can be performed to create composite chunks.

As can be seen, described herein is quasi-compaction that creates composite chunks from unused space of other chunks, to provide more free capacity in a data storage system without performing data copying. The quasi-compaction technology can be combined with other garbage collection technologies, such as an ownership-based technology for garbage collection (including for B+ trees) for facilitating collecting the garbage chunks and performing quasi-compacting in one cycle, and/or copying garbage collectors.

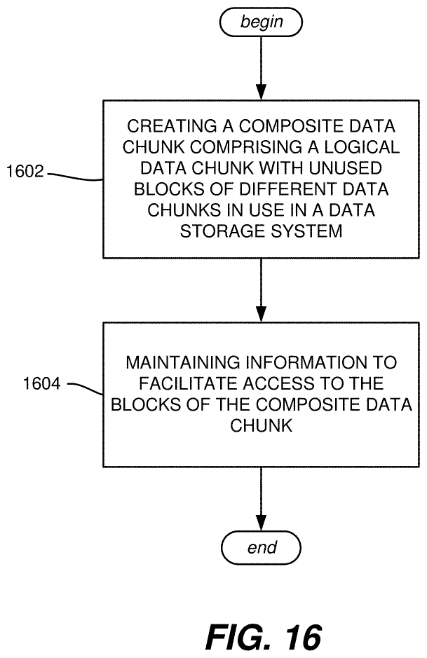

One or more aspects, generally exemplified in FIG. 16, can comprise example operations, e.g., of a system, comprising a processor and a memory that stores executable instructions that, when executed by the processor, facilitate performance of the operations. Operation 1602 represents creating a composite data chunk comprising a logical data chunk with unused blocks of different data chunks in use in a data storage system. Operation 1604 represents maintaining information to facilitate access to the blocks of the composite data chunk.

Further operations can comprise obtaining a group of data chunk identifiers corresponding to the data chunks in use, and for respective data chunk identifiers, obtaining respective unused fragment data indicating which one or more chunk fragments of a respective corresponding data chunk do not comprise live data; creating the composite data chunk can comprise selecting the unused blocks based on the respective unused fragment data.

Selecting the unused blocks based on the unused fragment data can comprise selecting the unused blocks based on a largest size corresponding to contiguous unused fragments. Obtaining the group of data chunk identifiers can comprise obtaining data structures comprising chunk identifiers and fragment data for chunks in use by nodes of the data storage system; further operations can comprise merging the data structures by replicated chunk identifiers in the data structures into a single chunk identifier. For each chunk identifier, the fragment data can comprise a fragment bitmap indicating the unused fragments, and the merging the data structures can comprise, for each of the replicated chunk identifiers, performing an OR operation of the fragment bitmaps of the replicated chunk identifiers.

Creating the composite data chunk can occur in conjunction with a garbage collection operation.

The composite data chunk can comprise a first composite data chunk; further operations can determining the creating the first composite data chunk results in available free capacity satisfying a free capacity threshold value, and in response to the determining indicating that the available free capacity does not satisfy the free capacity threshold value, creating a second composite data chunk with first ones of the unused blocks of the different data chunks in use that exclude second ones of the unused blocks of the first composite data chunk.

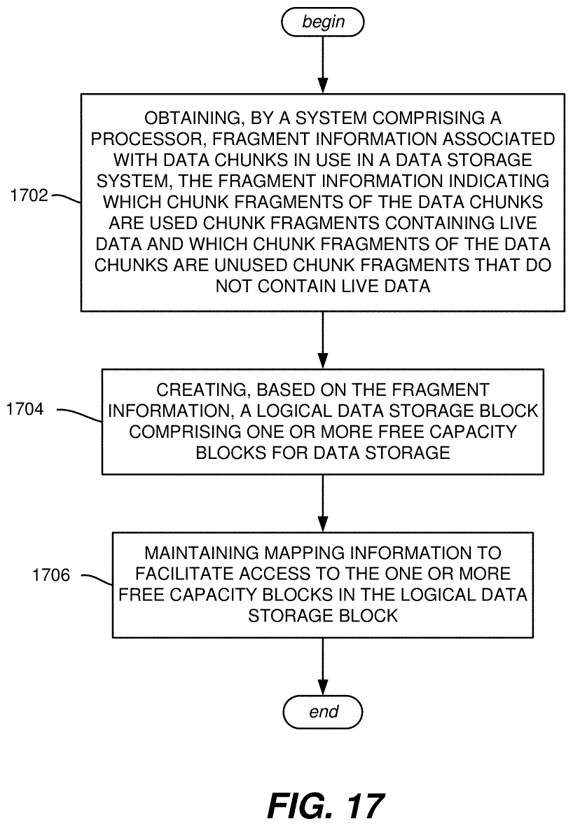

One or more aspects, generally exemplified in FIG. 17, can comprise example operations, e.g., of a method. Operation 1702 represents obtaining, by a system comprising a processor, fragment information associated with data chunks in use in a data storage system, the fragment information indicating which chunk fragments of the data chunks are used chunk fragments containing live data and which chunk fragments of the data chunks are unused chunk fragments that do not contain live data. Operation 1704 represents creating, based on the fragment information, a logical data storage block comprising one or more free capacity blocks for data storage. Operation 1706 represents maintaining mapping information to facilitate access to the one or more free capacity blocks in the logical data storage block.

Obtaining the fragment information can comprise obtaining a dataset comprising chunk identifiers of the data chunks in use and associated fragment data structures, wherein for each chunk identifier that identifies a data chunk in use, an associated fragment data structure can indicate which first one or more of the fragments of the data chunk are part of the used data fragments and which second one or more of the fragments of the data chunk are part of unused data fragments.

Obtaining the dataset can comprise obtaining the dataset as part of a garbage collection operation that deletes data chunks that are owned by an owning node that owns the data chunks and are not identified by chunk identifiers in the dataset that identifies the data chunks in use.

Obtaining the fragment information can comprise obtaining datasets from different nodes of the data storage system, the datasets comprising chunk identifiers of the data chunks in use and associated fragment bitmaps, and further comprising, generating the fragment information, comprising, for each chunk identifier that identifies a data chunk and is listed in more than one dataset of the datasets, combining the fragment bitmaps associated with the chunk identifier in the datasets by performing a logical OR operation of the fragment bitmaps.

Creating the logical data storage block can comprise generating a fragment index; the fragment index, for each chunk identifier of an unused data chunk, can relate the chunk identifier to a fragment offset value of one or more contiguous unused fragments within the unused data chunk, and to a size value that corresponds to a combined size of the one or more contiguous unused fragments.

Creating the logical data storage block can comprise sorting the fragment index by size values, and, based on the sorting, selecting one or more fragments for the logical data storage block based on a largest size value.

Creating the logical data storage block can comprise selecting contiguous fragments for the logical data storage block based on a combined size of the contiguous fragments.

The logical data storage block can comprise a first logical data storage block; aspects can comprise determining whether the creating the first logical data storage block results in available free capacity meeting a free capacity threshold value, and if not, creating, based on the fragment information, a second logical data storage block.

Creating the logical data storage block can comprise combining unused chunk fragments from different data chunks into a composite data chunk.

Maintaining the mapping information to facilitate access to the one or more free capacity blocks in the logical data storage block can comprise maintaining, for the composite data chunk, chunk identifiers of the different data chunks in association with data values corresponding to addresses within the different data chunks.

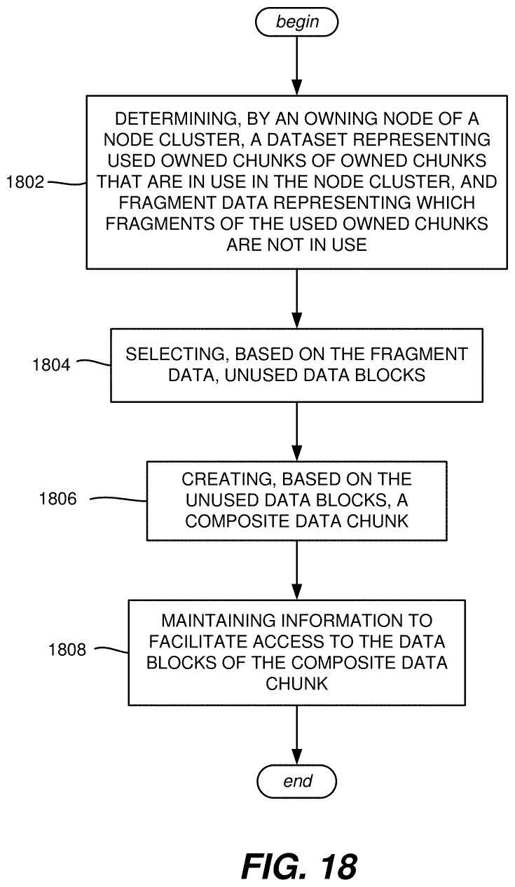

One or more aspects, such as implemented in a machine-readable storage medium, comprising executable instructions that, when executed by a processor, facilitate performance of operations, can be directed towards operations exemplified in FIG. 18. Example operation 1802 represents determining, by an owning node of a node cluster, a dataset representing used owned chunks of owned chunks that are in use in the node cluster, and fragment data representing which fragments of the used owned chunks are not in use/Example operation 1804 represents selecting, based on the fragment data, unused data blocks. Example operation 1806 represents creating, based on the unused data blocks, a composite data chunk. Example operation 1808 represents maintaining information to facilitate access to the data blocks of the composite data chunk.

Creating the composite data chunk can comprise creating a first composite data chunk; further operations can comprise, in response to determining that the creating the first composite data chunk results in available free storage capacity being less than a free storage capacity threshold value, creating a second composite data chunk with unused blocks of different data chunks in use that do not include the unused blocks of the first composite data chunk. The dataset can be a first dataset, and further operations can comprise determining a second dataset representing unused owned chunks that are not in use in the node cluster, and garbage collecting the unused owned chunks.

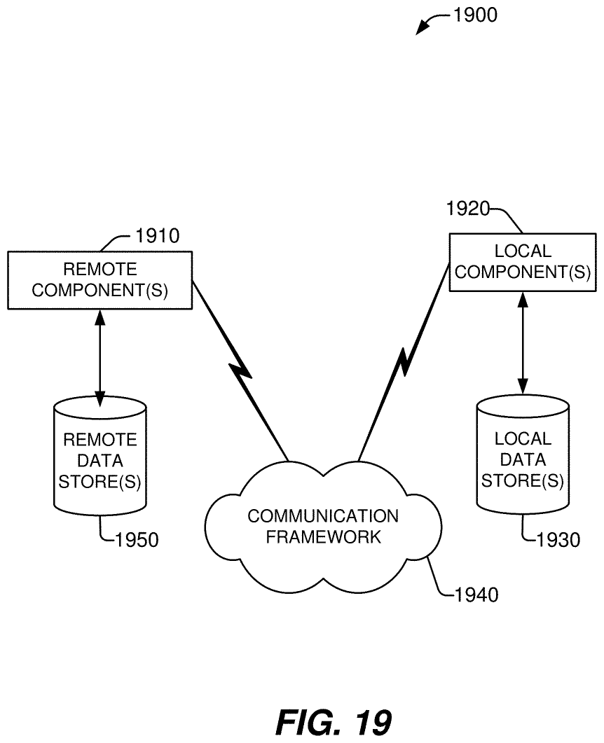

FIG. 19 is a schematic block diagram of a computing environment 1900 with which the disclosed subject matter can interact. The system 1900 comprises one or more remote component(s) 1910. The remote component(s) 1910 can be hardware and/or software (e.g., threads, processes, computing devices). In some embodiments, remote component(s) 1910 can be a distributed computer system, connected to a local automatic scaling component and/or programs that use the resources of a distributed computer system, via communication framework 1940. Communication framework 1940 can comprise wired network devices, wireless network devices, mobile devices, wearable devices, radio access network devices, gateway devices, femtocell devices, servers, etc.

The system 1900 also comprises one or more local component(s) 1920. The local component(s) 1920 can be hardware and/or software (e.g., threads, processes, computing devices). In some embodiments, local component(s) 1920 can comprise an automatic scaling component and/or programs that communicate/use the remote resources 1910 and 1920, etc., connected to a remotely located distributed computing system via communication framework 1940.

One possible communication between a remote component(s) 1910 and a local component(s) 1920 can be in the form of a data packet adapted to be transmitted between two or more computer processes. Another possible communication between a remote component(s) 1910 and a local component(s) 1920 can be in the form of circuit-switched data adapted to be transmitted between two or more computer processes in radio time slots. The system 1900 comprises a communication framework 1940 that can be employed to facilitate communications between the remote component(s) 1910 and the local component(s) 1920, and can comprise an air interface, e.g., Uu interface of a UMTS network, via a long-term evolution (LTE) network, etc. Remote component(s) 1910 can be operably connected to one or more remote data store(s) 1950, such as a hard drive, solid state drive, SIM card, device memory, etc., that can be employed to store information on the remote component(s) 1910 side of communication framework 1940. Similarly, local component(s) 1920 can be operably connected to one or more local data store(s) 1930, that can be employed to store information on the local component(s) 1920 side of communication framework 1940.

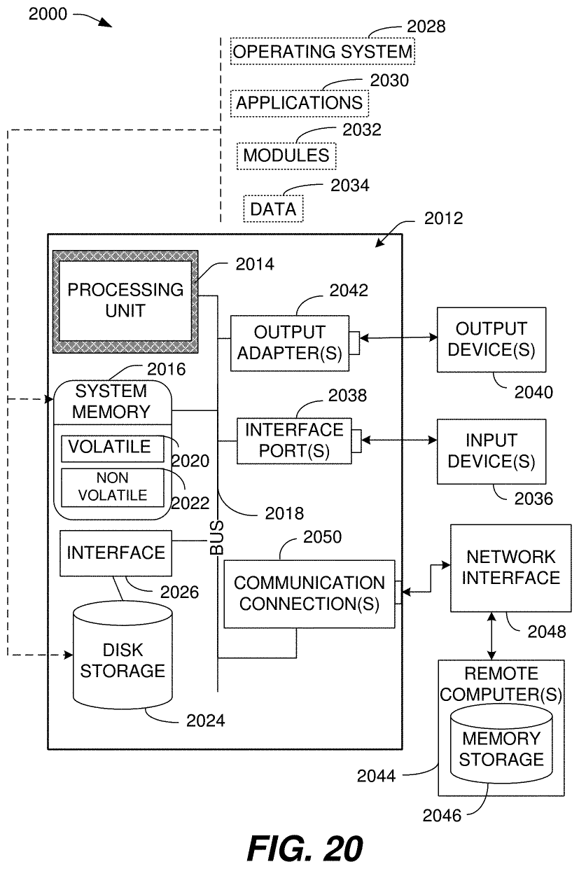

In order to provide a context for the various aspects of the disclosed subject matter, FIG. 20, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 2020 (see below), non-volatile memory 2022 (see below), disk storage 2024 (see below), and memory storage 2046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 20 illustrates a block diagram of a computing system 2000 operable to execute the disclosed systems and methods in accordance with one or more embodiments/implementations described herein. Computer 2012, can comprise a processing unit 2014, a system memory 2016, and a system bus 2018. System bus 2018 couples system components comprising, but not limited to, system memory 2016 to processing unit 2014. Processing unit 2014 can be any of various available processors. Dual microprocessors and other multiprocessor architectures also can be employed as processing unit 2014.

System bus 2018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers), and small computer systems interface.

System memory 2016 can comprise volatile memory 2020 and nonvolatile memory 2022. A basic input/output system, containing routines to transfer information between elements within computer 2012, such as during start-up, can be stored in nonvolatile memory 2022. By way of illustration, and not limitation, nonvolatile memory 2022 can comprise read only memory, programmable read only memory, electrically programmable read only memory, electrically erasable read only memory, or flash memory. Volatile memory 2020 comprises read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 2012 can also comprise removable/non-removable, volatile/non-volatile computer storage media. FIG. 20 illustrates, for example, disk storage 2024. Disk storage 2024 comprises, but is not limited to, devices like a magnetic disk drive, floppy disk drive, tape drive, flash memory card, or memory stick. In addition, disk storage 2024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 2024 to system bus 2018, a removable or non-removable interface is typically used, such as interface 2026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, can cause a system comprising a processor to perform operations, comprising determining a mapped cluster schema, altering the mapped cluster schema until a rule is satisfied, allocating storage space according to the mapped cluster schema, and enabling a data operation corresponding to the allocated storage space, as disclosed herein.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 20 describes software that acts as an intermediary between users and computer resources described in suitable operating environment 2000. Such software comprises an operating system 2028. Operating system 2028, which can be stored on disk storage 2024, acts to control and allocate resources of computer system 2012. System applications 2030 take advantage of the management of resources by operating system 2028 through program modules 2032 and program data 2034 stored either in system memory 2016 or on disk storage 2024. It is to be noted that the disclosed subject matter can be implemented with various operating systems or combinations of operating systems.

A user can enter commands or information into computer 2012 through input device(s) 2036. In some embodiments, a user interface can allow entry of user preference information, etc., and can be embodied in a touch sensitive display panel, a mouse/pointer input to a graphical user interface (GUI), a command line controlled interface, etc., allowing a user to interact with computer 2012. Input devices 2036 comprise, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 2014 through system bus 2018 by way of interface port(s) 2038. Interface port(s) 2038 comprise, for example, a serial port, a parallel port, a game port, a universal serial bus, an infrared port, a Bluetooth port, an IP port, or a logical port associated with a wireless service, etc. Output device(s) 2040 use some of the same type of ports as input device(s) 2036.

Thus, for example, a universal serial busport can be used to provide input to computer 2012 and to output information from computer 2012 to an output device 2040. Output adapter 2042 is provided to illustrate that there are some output devices 2040 like monitors, speakers, and printers, among other output devices 2040, which use special adapters. Output adapters 2042 comprise, by way of illustration and not limitation, video and sound cards that provide means of connection between output device 2040 and system bus 2018. It should be noted that other devices and/or systems of devices provide both input and output capabilities such as remote computer(s) 2044.

Computer 2012 can operate in a networked environment using logical connections to one or more remote computers, such as remote computer(s) 2044. Remote computer(s) 2044 can be a personal computer, a server, a router, a network PC, cloud storage, a cloud service, code executing in a cloud computing environment, a workstation, a microprocessor-based appliance, a peer device, or other common network node and the like, and typically comprises many or all of the elements described relative to computer 2012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 2046 is illustrated with remote computer(s) 2044. Remote computer(s) 2044 is logically connected to computer 2012 through a network interface 2048 and then physically connected by way of communication connection 2050. Network interface 2048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 2050 refer(s) to hardware/software employed to connect network interface 2048 to bus 2018. While communication connection 2050 is shown for illustrative clarity inside computer 2012, it can also be external to computer 2012. The hardware/software for connection to network interface 2048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the invention is susceptible to various modifications and alternative constructions, certain illustrated implementations thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the invention is not to be limited to any single implementation, but rather is to be construed in breadth, spirit and scope in accordance with the appended claims.

What is claimed is:

1. A system, comprising:
a processor; and
a memory that stores executable instructions that, when executed by the processor, facilitate performance of operations, the operations comprising:
creating a composite data chunk comprising a logical data chunk with unused blocks of different data chunks in use in a data storage system; and
maintaining information to facilitate access to the blocks of the composite data chunk.

2. The system of claim 1, wherein the operations further comprise, obtaining a group of data chunk identifiers corresponding to the data chunks in use, and for respective data chunk identifiers, obtaining respective unused fragment data indicating which one or more chunk fragments of a respective corresponding data chunk do not comprise live data, and wherein the creating the composite data chunk comprises selecting the unused blocks based on the respective unused fragment data.

3. The system of claim 2, wherein the selecting the unused blocks based on the unused fragment data comprises selecting the unused blocks based on a largest size corresponding to contiguous unused fragments.

4. The system of claim 2, wherein the obtaining the group of data chunk identifiers comprises obtaining data structures comprising chunk identifiers and fragment data for chunks in use by nodes of the data storage system, and wherein the operations further comprise, merging the data structures by replicated chunk identifiers in the data structures into a single chunk identifier.

5. The system of claim 4, wherein, for each chunk identifier, the fragment data comprises a fragment bitmap indicating the unused fragments, and wherein the merging the data structures further comprises, for each of the replicated chunk identifiers, performing an OR operation of the fragment bitmaps of the replicated chunk identifiers.

6. The system of claim 1, wherein the creating the composite data chunk occurs in conjunction with a garbage collection operation.

7. The system of claim 1, wherein the composite data chunk comprises a first composite data chunk, and wherein the operations further comprise determining whether the creating the first composite data chunk results in available free capacity satisfying a free capacity threshold value, and in response to the determining indicating that the available free capacity does not satisfy the free capacity threshold value, creating a second composite data chunk with first ones of the unused blocks of the different data chunks in use that exclude second ones of the unused blocks of the first composite data chunk.

8. A method comprising:
obtaining, by a system comprising a processor, fragment information associated with data chunks in use in a data storage system, the fragment information indicating which chunk fragments of the data chunks are used chunk fragments containing live data and which chunk fragments of the data chunks are unused chunk fragments that do not contain live data;
creating, based on the fragment information, a logical data storage block comprising one or more free capacity blocks for data storage; and
maintaining mapping information to facilitate access to the one or more free capacity blocks in the logical data storage block.

9. The method of claim 8, wherein the obtaining the fragment information comprises obtaining a dataset comprising chunk identifiers of the data chunks in use and associated fragment data structures, wherein for each chunk identifier that identifies a data chunk in use, an associated fragment data structure indicates which first one or more of the fragments of the data chunk are part of the used data fragments and which second one or more of the fragments of the data chunk are part of unused data fragments.

10. The method of claim 9, wherein the obtaining the dataset comprises obtaining the dataset as part of a garbage collection operation that deletes data chunks that are owned by an owning node that owns the data chunks and are not identified by chunk identifiers in the dataset that identifies the data chunks in use.

11. The method of claim 8, wherein the obtaining the fragment information comprises obtaining datasets from different nodes of the data storage system, the datasets comprising chunk identifiers of the data chunks in use and associated fragment bitmaps, and further comprising, generating the fragment information, comprising, for each chunk identifier that identifies a data chunk and is listed in more than one dataset of the datasets, combining the fragment bitmaps associated with the chunk identifier in the datasets by performing a logical OR operation of the fragment bitmaps.

12. The method of claim 8, wherein the creating the logical data storage block comprises generating a fragment index, and wherein the fragment index, for each chunk identifier of an unused data chunk, relates the chunk identifier to a fragment offset value of one or more contiguous unused fragments within the unused data chunk, and to a size value that corresponds to a combined size of the one or more contiguous unused fragments.

13. The method of claim 12, wherein the creating the logical data storage block comprises sorting the fragment index by size values, and, based on the sorting, selecting one or more fragments for the logical data storage block based on a largest size value.

14. The method of claim 8, wherein the creating the logical data storage block comprises selecting contiguous fragments for the logical data storage block based on a combined size of the contiguous fragments.

15. The method of claim 8, wherein the logical data storage block comprises a first logical data storage block, and further comprising, determining whether the creating the first logical data storage block results in available free capacity meeting a free capacity threshold value, and if not, creating, based on the fragment information, a second logical data storage block.

16. The method of claim 8, wherein the creating the logical data storage block comprises combining unused chunk fragments from different data chunks into a composite data chunk.

17. The method of claim 16, wherein the maintaining the mapping information to facilitate access to the one or more free capacity blocks in the logical data storage block comprises maintaining, for the composite data chunk, chunk identifiers of the different data chunks in association with data values corresponding to addresses within the different data chunks.

18. A machine-readable storage medium, comprising executable instructions that, when executed by a processor, facilitate performance of operations, the operations comprising:
determining, by an owning node of a node cluster, a dataset representing used owned chunks of owned chunks that are in use in the node cluster, and fragment data representing which fragments of the used owned chunks are not in use;
selecting, based on the fragment data, unused data blocks;
creating, based on the unused data blocks, a composite data chunk; and
maintaining information to facilitate access to the data blocks of the composite data chunk.

19. The machine-readable storage medium of claim 16, wherein the creating the composite data chunk comprises creating a first composite data chunk, and wherein the operations further comprise in response to determining that the creating the first composite data chunk results in available free storage capacity being less than a free storage capacity threshold value, creating a second composite data chunk with unused blocks of different data chunks in use that do not include the unused blocks of the first composite data chunk.

20. The machine-readable storage medium of claim 16, wherein the dataset is a first dataset, and wherein the operations further comprise, determining a second dataset representing unused owned chunks that are not in use in the node cluster, and garbage collecting the unused owned chunks.
